(19) United States
(12) Patent Application Publication
(10) Pub. No.: US 2019/0236020 A1
(43) Pub. Date: Aug. 1, 2019

(54) MEMORY SYSTEM AND OPERATING METHOD THEREOF

(71) Applicant: SK hynix Inc., Gyeonggi-do (KR)

(72) Inventor: Eun Soo JANG, Gyeonggi-do (KR)

(21) Appl. No.: 16/107,170

(22) Filed: Aug. 21, 2018

(30) Foreign Application Priority Data
Jan. 26, 2018 (KR) 10-2018-0009973

(51) Int. Cl. G06F 12/1009

(52) U.S. Cl. CPC G06F 12/1009; G06F 2212/202

(57) ABSTRACT

A memory system includes a nonvolatile memory device including a plurality of memory blocks; and a controller configured to generate an address mapping table based on a first mapping information on a first logical address set corresponding to host data, wherein the controller generates a second logical address set corresponding to metadata, and generates the address mapping table which includes a second mapping information on the second logical address set and the first mapping information.

### CROSS-REFERENCES TO RELATED APPLICATION

The present application claims priority under 35 U.S.C. § 119(a) to Korean application number 10-2018-0009973, filed on Jan. 26, 2018, in the Korean Intellectual Property Office, which is incorporated herein by reference in its entirety.

### BACKGROUND

### 1. Technical Field

Various embodiments of the present invention generally relate to a memory system. Particularly, the embodiments relate to a memory system including a nonvolatile memory device.

### 2. Related Art

A memory system may be configured to store the data provided from an external device, in response to a write request from the external device. Also, the memory system may be configured to provide stored data to the external device, in response to a read request from the external device. The external device may be an electronic device capable of processing data such as a computer, a digital camera, or a mobile phone. The memory system may operate by being built in the external device, or may operate by being manufactured in a separable form and being coupled to the external device.

Since there is no mechanical driving part, a memory system using a memory device provides advantages such as excellent stability and durability, high information access speed, low power consumption. Memory systems having such advantages include a universal serial bus (USB) memory device, memory cards having various interfaces, a universal flash storage (UFS) device, and a solid state drive (SSD).

### SUMMARY

Various embodiments generally relate to a memory system in which logical addresses are allocated to positions where metadata are stored.

In an embodiment, a memory system may include: a nonvolatile memory device including a plurality of memory blocks; and a controller configured to generate an address mapping table based on a first mapping information on a first logical address set corresponding to host data, wherein the controller generates a second logical address set corresponding to metadata, and generates the address mapping table which includes a second mapping information on the second logical address set and the first mapping information.

In an embodiment, a method for operating a memory system may include: generating, by a controller, logical addresses corresponding to metadata; generating, by the controller, an address mapping table including mapping information between physical addresses where the metadata are stored and the logical addresses; and accessing, by the controller, the nonvolatile memory device based on the address mapping table.

### BRIEF DESCRIPTION OF THE DRAWINGS

FIG. 1 is a block diagram illustrating a memory system in accordance with an embodiment.

FIG. 2 is a diagram illustrating setting information on metadata allocated to logical addresses in accordance with the embodiment.

FIG. 3 is a diagram illustrating an address mapping table in which user data and metadata are stored in a same open block in accordance with the embodiment.

FIG. 4 is a diagram illustrating data stored in an open block corresponding to an address mapping table in accordance with the embodiment.

FIG. 5 is a diagram illustrating an address mapping table including the update information of metadata in accordance with the embodiment.

FIG. 6 is a diagram illustrating data stored in an open block corresponding to an address mapping table in accordance with the embodiment.

FIG. 7 is a block diagram illustrating a controller in accordance with the embodiment.

FIG. 8 is a flow chart illustrating a method for operating a memory system in accordance with an embodiment.

FIG. 9 is a diagram illustrating a data processing system including a solid state drive (SSD) in accordance with an embodiment.

FIG. 10 is a diagram illustrating a data processing system including a memory system in accordance with an embodiment.

FIG. 11 is a diagram illustrating a data processing system including a memory system in accordance with an embodiment.

FIG. 12 is a diagram illustrating a network system including a memory system in accordance with an embodiment.

FIG. 13 is a block diagram illustrating a nonvolatile memory device included in a memory system in accordance with an embodiment.

### DETAILED DESCRIPTION

Advantages, features and methods for achieving the various embodiments of the present invention will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention. It is noted that reference to “an embodiment” does not necessarily mean only one embodiment, and different references to “an embodiment” are not necessarily to the same embodiment(s).

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

The terminology used herein is for the purpose of describing particular embodiments only and is not intended to be limiting of the present invention.

As used herein, singular forms may include the plural forms as well and vice versa, unless the context clearly indicates otherwise.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

Hereinafter, a memory system and an operating method thereof will be described below with reference to the accompanying drawings through various examples of embodiments.

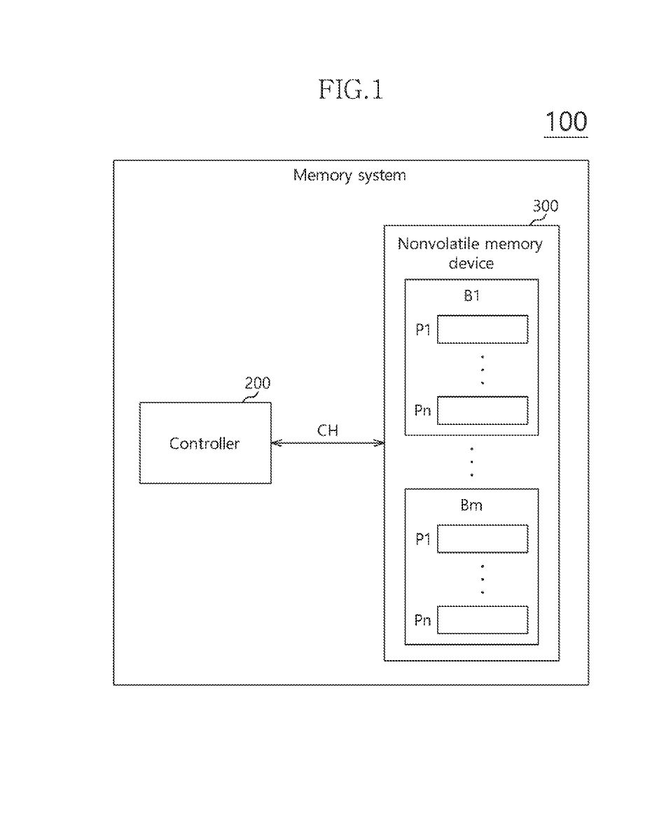

FIG. 1 is a block diagram illustrating a memory system 100 in accordance with an embodiment.

The memory system 100 may store data to be accessed by a host device (not shown) such as a mobile phone, an MP3 player, a laptop computer, a desktop computer, a game player, a television (TV), an in-vehicle infotainment system, and so forth.

The memory system 100 may be implemented as any one of various kinds of storage devices according to a host interface as a transmission protocol with the host device. For example, the memory system 100 may be implemented as any one of various kinds of storage devices such as a solid state drive (SSD), a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a Personal Computer Memory Card International Association (PCMCIA) card type storage device, a peripheral component interconnection (PCI) card type storage device, a PCI express (PCI-e or PCIe) card type storage device, a compact flash (CF) card, a smart media card, a memory stick, and so forth.

The memory system 100 may be manufactured as any one among various kinds of package types. For example, the memory system 100 may be manufactured as any one of various kinds of package types such as a package-on-package (POP), a system-in-package (SIP), a system-on-chip (SOC), a multi-chip package (MCP), a chip-on-board (COB), a wafer-level fabricated package (WFP) and a wafer-level stack package (WSP).

The memory system 100 may include a controller 200 and a nonvolatile memory device 300. The controller 200 may perform an operation based on a request from a host device (not shown). For example, the controller 200 may receive a write request from the host device, and store requested data in the nonvolatile memory device 300. For another example, the controller 200 may receive a read request from the host device, and may read out requested data from the nonvolatile memory device 300 and transmit the read-out requested data to the host device. The controller 200 may perform mapping between a logical address of the host device and a physical address of the nonvolatile memory device 300, and manage an address mapping table in which mapping information are stored.

The nonvolatile memory device 300 may include a plurality of memory blocks B1 to Bm. Each of the memory blocks B1 to Bm may include a plurality of pages P1 to Pn. From an operational viewpoint or a physical (or structural) viewpoint, the memory cells included in a memory cell region may be configured as a hierarchical memory cell set or memory cell unit. For example, memory cells which are coupled to the same word line and are to be read and written (or programmed) simultaneously may be configured as a page. In the following descriptions, for convenience, memory cells configured as a page will be referred to as a “page.” Also, memory cells to be erased simultaneously may be configured as a memory block.

Typically, regions of the blocks included in the nonvolatile memory device 300 are divided into regions where host data are stored, and regions where metadata are stored. That is, the metadata are stored separately from the host data. Also, information on positions where the metadata are stored are managed separately. In detail, while information on positions where the host data are stored are managed by the above-described address mapping table, information on positions where the metadata are stored are managed separately. In this scheme, since the information on the positions of the plurality of metadata are separately managed, inefficiency may be caused in terms of time. For example, after a sudden power-off (SPO) occurs, since it is necessary to read all blocks in which the metadata are stored, a device implementing a scheme in which the information on the positions of the metadata are separately managed may be inefficient.

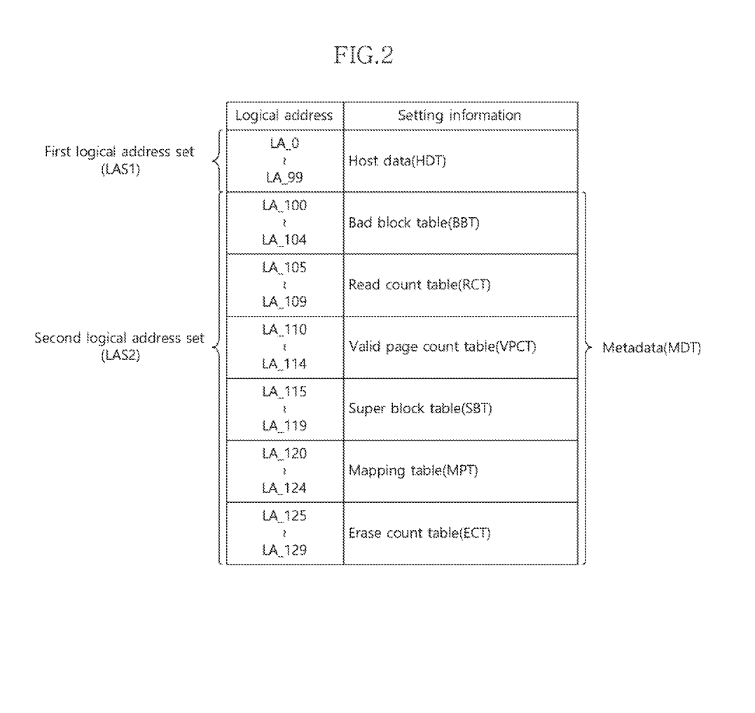

FIG. 2 is a diagram illustrating setting information on metadata allocated to logical addresses in accordance with the embodiment. For convenience, it is assumed that, in FIGS. 2 to 6, physical addresses where host data HDT are to be stored are mapped to logical addresses LA_0 to LA_99 which have logical address offsets “0” to “99”, and physical addresses where metadata MDT are to be stored are mapped to logical addresses LA_100 to LA_129 which have logical address offsets “100” to “129.” It is to be noted that this is for illustration purpose only and may be changed at any time.

Referring to FIG. 2, regions of blocks in the nonvolatile memory device 300 are divided into regions where host data HDT are stored, and regions where metadata MDT are stored. In metadata MDT, there may be included all remaining information and data excluding host data HDT corresponding to a request received from the host device. For example, the metadata MDT may be data such as a bad block table BBT, a read count table RCT, a valid page count table VPCT, a super block table SBT, a mapping table MPT, and an erase count table ECT for the memory blocks B1 to Bm of the nonvolatile memory device 300.

Referring again to FIGS. 1 and 2, the memory system 100 may include the controller 200 and the nonvolatile memory device 300 which includes the plurality of memory blocks B1 to Bm. The controller 200 may generate an address mapping table based on a first address mapping information on a first logical address set LAS1 corresponding to host data HDT. The controller 200 may generate a second logical address set LAS2 corresponding to metadata MDT, and may generate an address mapping table which includes a second mapping information on a second logical address set LAS2 and a first mapping information on a first logical address set LAS1. The first mapping information may include mapping information between the physical addresses of the nonvolatile memory device 300 in which the host data HDT are stored and the first logical address set LAS1. The second mapping information may include mapping information between the physical addresses of the nonvolatile memory device 300 in which the metadata MDT are stored and the second logical address set LAS2.

According to the embodiment, it is illustrated, as an example, that the first logical address set LAS1 may include the logical addresses LA_0 to LA_99 which have the offsets of 0 to 99, and the second logical address set LAS2 may include the logical addresses LA_100 to LA_129 which have the offsets 100 to 129. The following descriptions will be made based on this illustration.

The controller 200 may generate the second logical address set LAS2 corresponding to the metadata MDT. In detail, the controller 200 may separately generate the first logical address set LAS1 corresponding to the host data HDT, and the second logical address set LAS2 corresponding to the metadata MDT. The logical addresses LA_100 to LA_129 Included in the second logical address set LAS2 may be distinguished from the logical addresses LA_0 to LA_99, that is, the first logical address set LAS1, corresponding to the host data HDT as a target of a request of the host device such as a write request and/or a read request. The addresses included in the second logical address set LAS2 may be the logical addresses LA_100 to LA_129 necessary for performing operations in the controller 200. In other words, the logical addresses LA_100 to LA_129 included in the second logical address set LAS2 may be set as addresses outside the range of the logical addresses LA_0 to LA_99 included in the first logical address set LAS1. The controller 200 may generate the logical addresses LA_100 to LA_129 included in the second logical address set LAS2 to be distinguished from the logical addresses LA_0 to LA_99 included in the first logical address set LAS1.

According to the embodiment, the controller 200 may variably set the lengths of logical addresses, that is, the numbers of logical addresses, corresponding to respective metadata MDT. For example, the number of the offsets of logical addresses corresponding to a bad block table may be set to three logical addresses LA_100 to LA_102, and, if necessary, may be set to eight logical addresses LA_100 to LA_107.

According to the embodiment, physical addresses in which the bad block table BBT is to be stored may be mapped to the logical addresses LA_100 to LA_104. The states of the entire blocks B1 to Bm of the nonvolatile memory device 300 may be recorded or stored in the bad block table BBT. For instance, the good or bad states of the blocks B1 to Bm may be selectively recorded in the bad block table BBT. According to the embodiment, physical addresses in which the read count table RCT is to be stored may be mapped to the logical addresses LA_105 to LA_109. The read counts of the entire blocks B1 to Bm of the nonvolatile memory device 300 may be recorded or stored in the read count table RCT. For instance, the read counts may be recorded by the unit of block or by the unit of super block. According to the embodiment, physical addresses in which the valid page count table VPCT is to be stored may be mapped to the logical addresses LA_110 to LA_114. Valid page counts by the respective blocks of the nonvolatile memory device 300 may be recorded or stored in the valid page count table VPCT. The controller 200 may perform a garbage collection operation based on the information recorded in the valid page count table VPCT. According to the embodiment, physical addresses in which the super block table SBT is to be stored may be mapped to the logical addresses LA_115 to LA_119. Information on blocks which are grouped into super blocks may be recorded or stored in the super blocks table SBT. According to the embodiment, physical addresses in which the mapping table MPT is to be stored may be mapped to the logical addresses LA_120 to LA_124. Mapping information on logical addresses corresponding to physical addresses in which the host data HDT or the metadata MDT are stored may be recorded or stored in the mapping table MPT. According to the embodiment, physical addresses in which the erase count table ECT is to be stored may be mapped to the logical addresses LA_125 to LA_129. Erase counts of the entire blocks B1 to Bm of the nonvolatile memory device 300 may be recorded or stored in the erase count table ECT. The controller 200 may designate a corresponding block as a bad block or release the designation based on the erase count table ECT.

According to the embodiment, the controller 200 may generate a logical-to-physical (L2P) mapping table or a physical-to-logical (P2L) mapping table based on an address mapping information. In the L2P mapping table, logical addresses are set as indexes, and physical addresses mapped to the logical addresses are set as entries. In the P2L mapping table, physical addresses are set as indexes, and logical addresses mapped to the physical addresses are set as entries.

According to the embodiment, the controller 200 may store setting information on the metadata corresponding to the respective logical addresses included in the second logical address set LAS2, that is, the setting information shown in FIG. 2, in the nonvolatile memory device 300. The controller 200 may read out the setting information from the nonvolatile memory device 300 upon booting of the memory system 100, and store the read-out setting information in a working memory in the controller 200. While the working memory may be implemented by a dynamic random access memory (DRAM) or a static random access memory (SRAM), it is to be noted that the embodiment is not limited thereto and the working memory may be implemented by all kinds of memory devices.

As shown, the controller 200 may generate the logical addresses included in the second logical address set LAS2, by distinguishing them from the logical addresses included in the first logical address set LAS1.

According to the embodiment, the controller 200 may control the nonvolatile memory device 300 in such a manner that the host data HDT and the metadata MDT may be stored in a same memory block, which will be described in more detail below.

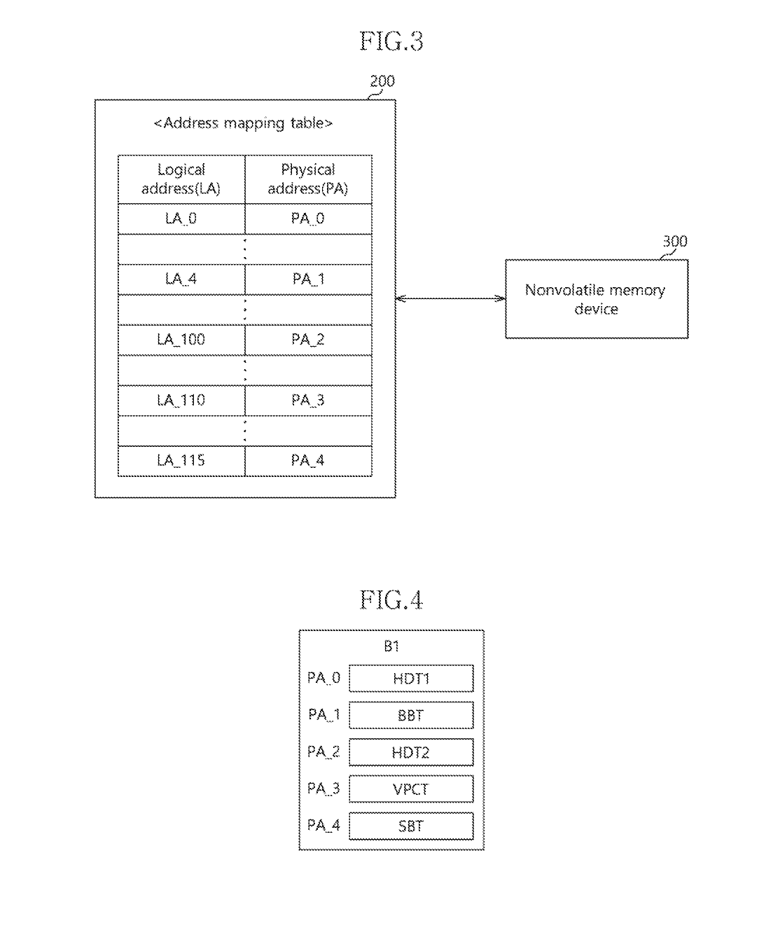

FIG. 3 is a diagram illustrating an address mapping table in which host data and metadata are stored in the same open block in accordance with the embodiment. FIG. 4 is a diagram illustrating data stored in an open block corresponding to an address mapping table, for example, the address mapping table of FIG. 3. While it is illustrated in FIG. 3 and FIG. 4, as an example, that the first block B1 includes five pages, this is merely for illustrative purposes, and it is to be noted that the present invention is not limited thereto.

The plurality of memory blocks B1 to BLm included in the nonvolatile memory device 300 may be divided into a memory block for which a write operation is completed, a memory block for which a write operation is being performed and a memory block for which a write operation is not started. In the present specification, for convenience, a memory block for which a write operation is completed will be referred to as a closed block, and a memory block for which a write operation is being performed will be referred to as an open block.

Referring to FIGS. 1 to 4, the controller 200 may control the nonvolatile memory device 300 in such a manner that the host data HDT and the metadata MDT may be stored in the same memory block. Namely, there may be a case where the host data HDT and the metadata MDT are stored in the same open block. The logical address LA_0, the logical address LA_4, the logical address LA_100, the logical address LA_110, and the logical address LA_115 may be mapped to a physical address PA_0, a physical address PA_2, a physical address PA_1, a physical address PA_3, and a physical address PA_4, respectively (see FIG. 3). In detail, first host data HDT1, the bad block table BBT, second host data HDT2, the valid page count table VPCT, and the super block table SBT may be stored in the physical address PA_0 to the physical address PA_4 of the open block B1, respectively (see FIG. 4). That is, the host data HDT and the metadata MDT may be stored in the same open block B1.

In the case where the host data HDT and the metadata MDT are stored in the same open block, the utilization of blocks may be improved when compared to a case where the host data HDT and the metadata MDT are separately stored in blocks in which the host data HDT are stored and blocks in which the metadata MDT are stored. Also, without the necessity of separately managing information on positions where the metadata MDT are stored, the information on positions where the metadata MDT are stored may be managed in the same manner as information on positions where the host data HDT are stored, by using the address mapping table. Further, because the number of blocks to be read out in the nonvolatile memory device 300 after a sudden power-off (SOP) occurs decreases, a booting time may be shortened.

According to the embodiment, invalidated metadata MDT may be determined by referring to the address mapping table. This will be described below in detail.

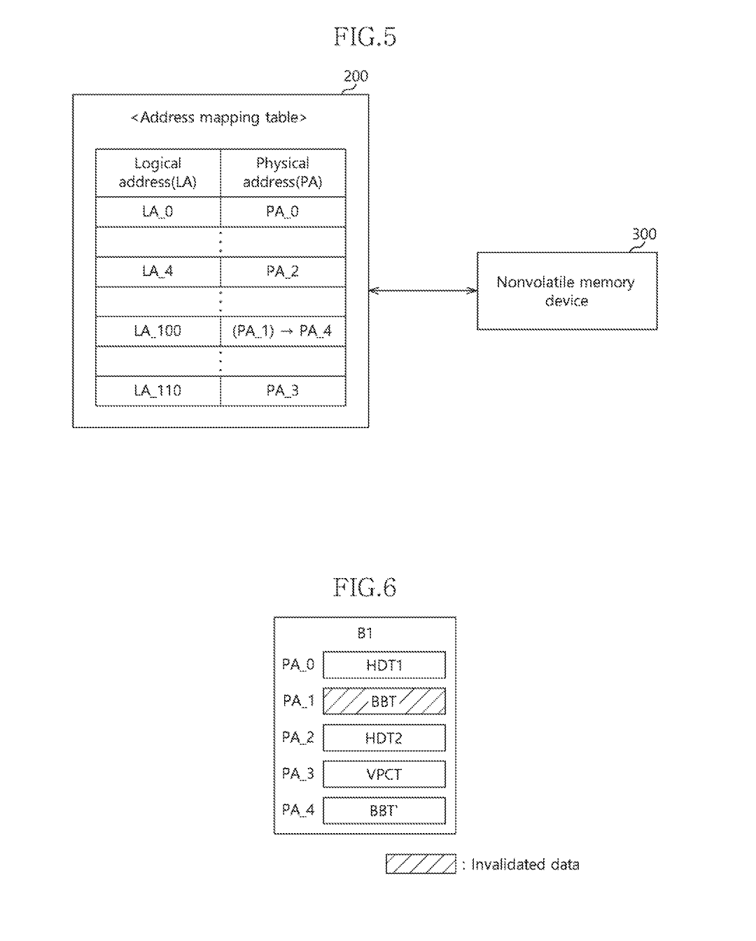

FIG. 5 is a diagram illustrating an address mapping table including the update information of metadata according to the embodiment. FIG. 6 is a diagram illustrating data stored in an open block corresponding to an address mapping table in accordance with the embodiment, for example, the address mapping table of FIG. 5. While it is illustrated in FIG. 5 and FIG. 6, as an example, that the first block B1 includes five pages, this is merely for illustrative purpose, and it is to be noted that the present invention is not limited thereto.

Referring to FIGS. 1, 5 and 6, the logical address LA_0, the logical address LA_4, the logical address LA_100 the logical address LA_110 may be mapped to the physical address PA_0, the physical address PA_2, the physical address PA_4, and the physical address PA_3, respectively (see FIG. 5). In detail, first host data HDT1, the bad block table BBT, second host data HDT2, the valid page count table VPCT, and a bad block table BBT′ may be stored in the physical address PA_0 to the physical address PA_4, respectively (see FIG. 6). It is assumed that the bad block table BBT′ stored in the page of the physical address PA_4 is information stored at a later time than the bad block table BBT stored in the page of the physical address PA_1. That is, the bad block table BBT′ is information obtained by updating the bad block table BBT.

According to the embodiment, the address mapping table may include the update information of the metadata MDT. The physical address PA_1 may be invalidated by the physical address PA_4 in which the updated bad block table BBT′ is stored. In other words, validity or invalidity of information on the metadata MDT may be checked by the information stored in the mapping table. The controller 200 may confirm the metadata MDT serving as a basis for an operation such as a garbage collection operation and a read reclaim operation, in the address mapping table.

In the case where the host data HDT and the metadata MDT are stored in the same open block and validity or invalidity of information on the mapping data MDT is checked through the address mapping table in the same manner as the case of the host data HDT, the checking time may be relatively shortened, and the efficiency of an operation may be relatively improved. In contrast, in the case where information on the positions of the metadata MDT are checked and validity or invalidity of information on the metadata MDT is checked by reading out the information on the positions of the metadata MDT, the checking time may be relatively increase.

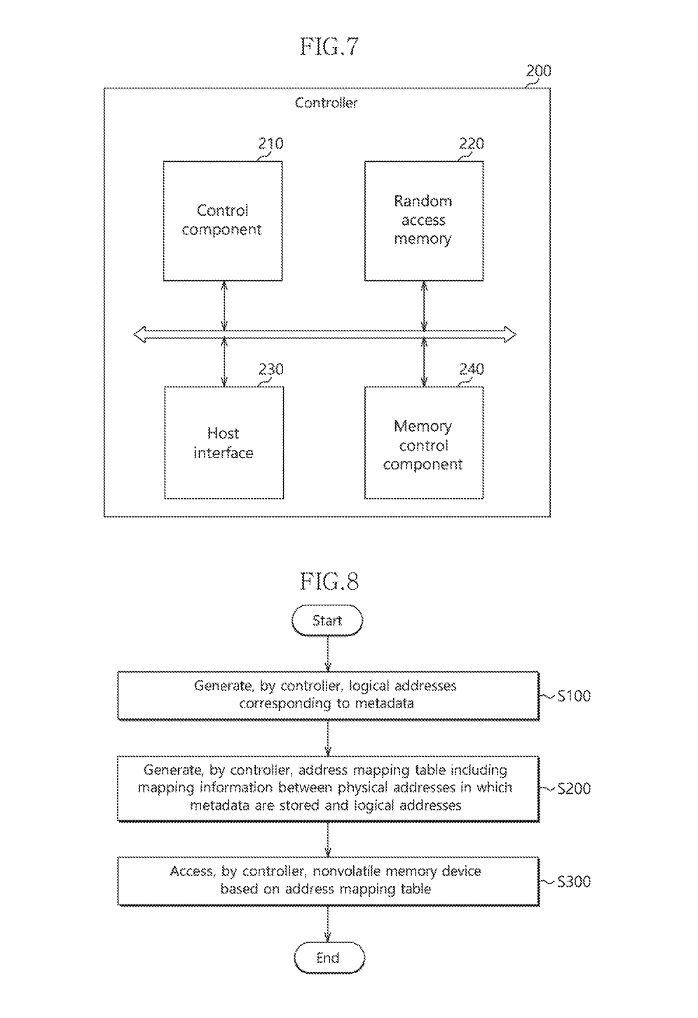

FIG. 7 is a block diagram illustrating a controller, for example, the controller 200 of FIG. 1 in accordance with the embodiment.

Referring to FIG. 7, the controller 200 may include a control component 210, a random access memory 220, a host interface 230 and a memory control component 240.

The control component 210 may be implemented by a micro control unit (MCU) or a central processing unit (CPU). The control component 210 may process a request which is received from a host device (not shown). In order to process the request, the control component 210 may drive an instruction or algorithm of a code type, that is, firmware (FW), loaded in the random access memory 220, and may control internal function blocks and the nonvolatile memory device 300 of FIG. 1.

The random access memory 220 may be implemented by a random access memory such as a dynamic random access memory (DRAM) or a static random access memory (SRAM). The random access memory 220 may store the firmware (FW) which is to be driven by the control component 210. Also, the random access memory 220 may store data necessary for driving the firmware (FW), for example, metadata. That is, the random access memory 220 may operate as the working memory of the control component 210.

The host interface 230 may interface the host device and the memory system 100 as shown in FIG. 1. For instance, the host interface 230 may communicate with the host device through any one of standard transmission protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-e or PCIe) and universal flash storage (UFS).

The memory control component 240 may control a storage medium, for example, the nonvolatile memory device 300, according to the control of the control component 210. The memory control component 240 may also be referred to as a memory interface. The memory control component 240 may provide control signals to the nonvolatile memory device 300. The control signals may include a command, an address, a control signal and so forth for controlling the nonvolatile memory device 300. The memory control component 240 may provide data to the nonvolatile memory device 300 or may be provided with data from the nonvolatile memory device 300.

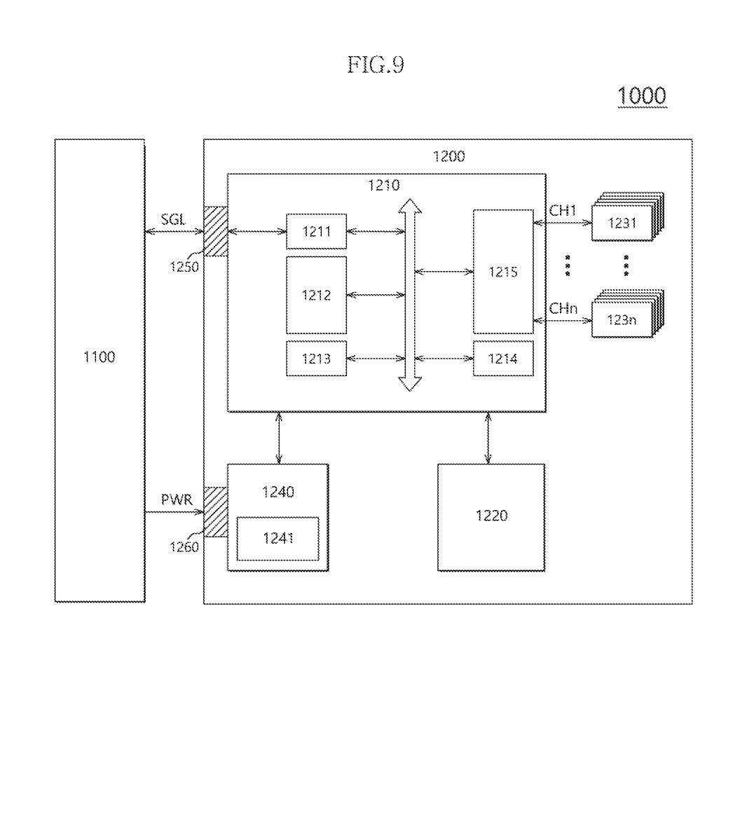

FIG. 8 is a flow chart illustrating a method for operating a memory system in accordance with an embodiment. For example, the method of FIG. 8 may be performed by the controller 200 of FIG. 1.

Referring to FIG. 8, the method may include operations S100, S200 and S300. In the operation S100, the controller 200 may generate logical addresses corresponding to metadata. In the operation S200, the controller 200 may generate an address mapping table including mapping information between physical addresses where the metadata are stored and the logical addresses. In the operation S300, the controller 200 may access the nonvolatile memory device 300 based on the address mapping table.

FIG. 9 is a diagram illustrating a data processing system 1000 in accordance with an embodiment. Referring to FIG. 9, the data processing system 1000 may include a host device 1100 and a solid state drive (SSD) 1200.

The SSD 1200 may include a controller 1210, a buffer memory device 1220, nonvolatile memory devices 1231 to 123n, a power supply 1240, a signal connector 1250, and a power connector 1260.

The controller 1210 may control general operations of the SSD 1200. The controller 1210 may include a host interface 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and so forth. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-e or PCIe) and universal flash storage (UFS).

The control component 1212 may analyze and process a signal SGL inputted from the host device 1100. The control component 1212 may control operations of internal function blocks according to a firmware or a software for driving the SSD 1200. The random access memory 1213 may be used as a working memory for driving such a firmware or software.

The ECC component 1214 may generate the parity data of data to be transmitted to the nonvolatile memory devices 1231 to 123n. The generated parity data may be stored together with the data in the nonvolatile memory devices 1231 to 123n. The ECC component 1214 may detect an error of the data read out from the nonvolatile memory devices 1231 to 123n, based on the parity data. If a detected error is within a correctable range, the ECC component 1214 may correct the detected error.

The memory interface 1215 (may also be referred to as memory control component 1215) may provide control signals such as commands and addresses to the nonvolatile memory devices 1231 to 123n, according to the control of the control component 1212. Moreover, the memory interface 1215 may exchange data with the nonvolatile memory devices 1231 to 123n, according to the control of the control component 1212. For example, the memory interface 1215 may provide the data stored in the buffer memory device 1220, to the nonvolatile memory devices 1231 to 123n, or provide the data read out from the nonvolatile memory devices 1231 to 123n, to the buffer memory device 1220.

The buffer memory device 1220 may temporarily store data to be stored in the nonvolatile memory devices 1231 to 123n. Further, the buffer memory device 1220 may temporarily store the data read out from the nonvolatile memory devices 1231 to 123n. The data temporarily stored in the buffer memory device 1220 may be transmitted to the host device 1100 or the nonvolatile memory devices 1231 to 123n according to the control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the interior of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include at least one capacitor having large capacity.

The signal connector 1250 may be implemented by various types of connectors depending on an interface scheme between the host device 1100 and the SSD 1200.

The power connector 1260 may be implemented by various types of connectors depending on a power supply scheme of the host device 1100.

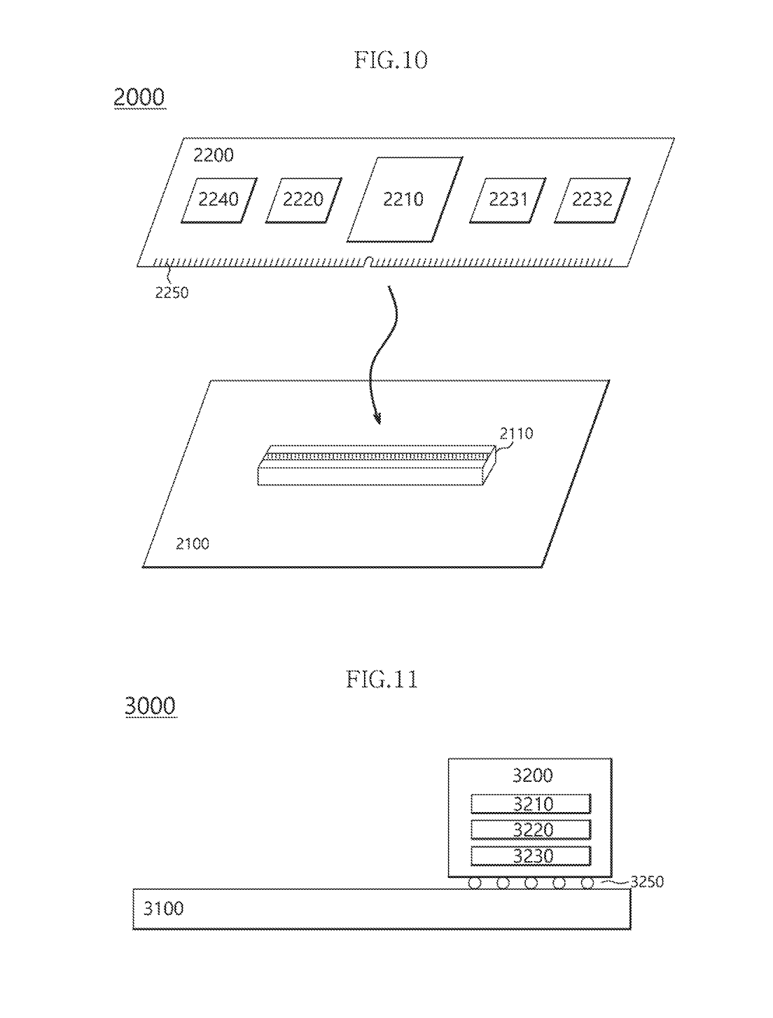

FIG. 10 is a diagram illustrating a data processing system 2000 in accordance with an embodiment. Referring to FIG. 10, the data processing system 2000 may include a host device 2100 and a memory system 2200.

The host device 2100 may be implemented in the form of a board such as a printed circuit board. Although not shown, the host device 2100 may include internal function blocks for performing functions.

The host device 2100 may include a connection terminal 2110 such as a socket, a slot or a connector. The memory system 2200 may be mounted to the connection terminal 2110.

The memory system 2200 may be implemented in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control the general operations of the memory system 2200. The controller 2210 may be implemented in the same manner as the controller 1210 shown in FIG. 9.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as the storage media of the memory system 2200.

The PMIC 2240 may provide the power inputted through the connection terminal 2250, to the interior of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be constructed into various types depending on an interface scheme between the host device 2100 and the memory system 2200. The connection terminal 2250 may be disposed on any one side of the memory system 2200.

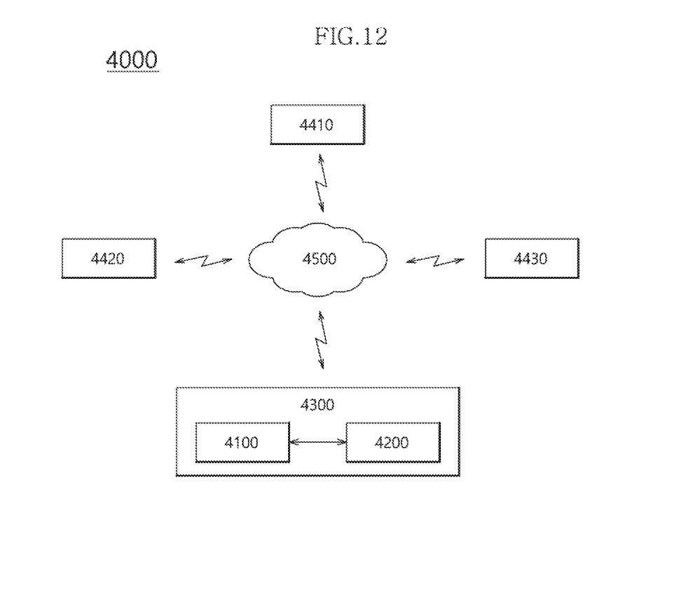

FIG. 11 is a diagram illustrating a data processing system 3000 in accordance with an embodiment. Referring to FIG. 11, the data processing system 3000 may include a host device 3100 and a memory system 3200.

The host device 3100 may be implemented in the form of a board such as a printed circuit board. Although not shown, the host device 3100 may include internal function blocks for performing functions.

The memory system 3200 may be implemented in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control the general operations of the memory system 3200. The controller 3210 may be configured in the same manner as the controller 1210 shown in FIG. 9.

The buffer memory device 3220 may temporarily store data to be stored in the nonvolatile memory device 3230. Further, the buffer memory device 3220 may temporarily store the data read out from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

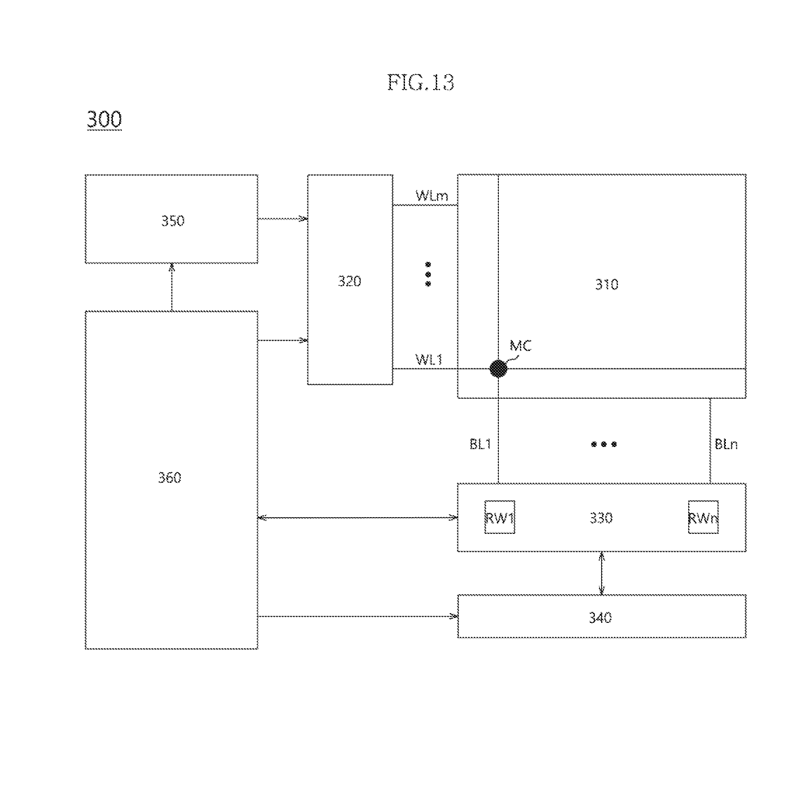

FIG. 12 is a diagram illustrating a network system 4000 in accordance with an embodiment. Referring to FIG. 12, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be implemented by the memory system 100 of FIG. 1, the SSD 1200 of FIG. 9, the memory system 2200 of FIG. 10 or the memory system 3200 of FIG. 11.

FIG. 13 is a block diagram illustrating a nonvolatile memory device 300 in accordance with an embodiment. Referring to FIG. 13, the nonvolatile memory device 300 may include a memory cell array 310, a row decoder 320, a data read and write (read/write) block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to the control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to the control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to the control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines (or data input/output buffers), based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For still another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control the general operations of the nonvolatile memory device 300, based on control signals provided from the external device. For example, the control logic 360 may control the read, write and erase operations of the nonvolatile memory device 300.

The descriptions for the above-described system may be applied to the methods in accordance with the embodiments. Therefore, descriptions the same as the descriptions for the above-described system are omitted in the methods.

While various embodiments have been described above, it will be understood to those skilled in the art that the embodiments described are examples only. Accordingly, the memory system and the operating method thereof described herein should not be limited based on the described embodiments.

What is claimed is:

1. A memory system comprising:
a nonvolatile memory device including a plurality of memory blocks; and
a controller configured to generate an address mapping table based on a first mapping information on a first logical address set corresponding to host data,
wherein the controller generates a second logical address set corresponding to metadata, and generates the address mapping table which includes a second mapping information on the second logical address set and the first mapping information.

2. The memory system according to claim 1,
wherein the first mapping information includes mapping information between physical addresses of the nonvolatile memory device in which the host data are stored and the first logical address set, and
wherein the second mapping information includes mapping information between physical addresses of the nonvolatile memory device in which the metadata are stored and the second logical address set.

3. The memory system according to claim 1, wherein the controller accesses the nonvolatile memory device based on the address mapping table.

4. The memory system according to claim 1, wherein the controller stores setting information on the metadata corresponding to respective logical addresses included in the second logical address set, in the nonvolatile memory device.

5. The memory system according to claim 4, wherein the controller reads out the setting information from the nonvolatile memory device when booting the memory system, and stores the read-out setting information in a working memory.

6. The memory system according to claim 1, wherein the metadata include at least one among a bad block table, a read count table, a valid page count table, a super block table, the address mapping table, and an erase count table.

7. The memory system according to claim 1, wherein the controller generates logical addresses included in the second logical address set, which are distinguished from logical addresses included in the first logical address set.

8. The memory system according to claim 1, wherein the controller controls the nonvolatile memory device in such a manner that the host data and the metadata are stored in the same memory block.

9. A method for operating a memory system, comprising:
generating, by a controller, logical addresses corresponding to metadata;
generating, by the controller, an address mapping table including mapping information between physical addresses where the metadata are stored and the logical addresses; and
accessing, by the controller, the nonvolatile memory device based on the address mapping table.

10. The method according to claim 9, further comprising:
generating, by the controller, setting information on the metadata corresponding to the respective logical addresses.

11. The method according to claim 10, further comprising:
transmitting, by the controller, the setting information to the nonvolatile memory device; and
storing, by the nonvolatile memory device, the setting information.

12. The method according to claim 11, further comprising:
reading out the setting information from the nonvolatile memory device when booting the memory system and storing the read-out setting information in a working memory, by the controller.

13. The method according to claim 9, wherein the metadata include at least one among a bad block table, a read count table, a valid page count table, a super block table, the address mapping table, and an erase count table.

14. The method according to claim 9, further comprising:
allocating, by the controller, memory blocks such that the host data and the metadata may be stored in the same block.

15. The method according to claim 9, wherein the generating of the logical addresses comprises:
generating the logical addresses, which are distinguished from logical addresses corresponding to the host data.
